(19) United States
(12) Patent Application Publication
(10) Pub. No.: US 2025/0005436 A1
(43) Pub. Date: Jan. 2, 2025

(54) AUTOMATIC GENERATION OF ATTRIBUTES BASED ON SEMANTIC CATEGORIZATION OF LARGE DATASETS IN ARTIFICIAL INTELLIGENCE MODELS AND APPLICATIONS

(71) Applicants: Andrzej Janusz, Warsaw (PL); Daniel Kaluza, Warsaw (PL); Dominik Slezak, Warsaw (PL); Sebastian Stawicki, Warsaw (PL)

(72) Inventors: Andrzej Janusz, Warsaw (PL); Daniel Kaluza, Warsaw (PL); Dominik Slezak, Warsaw (PL); Sebastian Stawicki, Warsaw (PL)

(21) Appl. No.: 18/217,520

(22) Filed: Jun. 30, 2023

(51) Int. Cl. G06N 20/00

(52) U.S. Cl. CPC G06N 20/00

(57) ABSTRACT

Disclosed is a method and system to automatically generate attributes based on semantic categorization of large datasets in artificial intelligence models and/or applications. In one embodiment, a method of automatic representation of data includes organizing a substantial dataset in a manner through which it can serve as an input to a machine learning model and/or an artificial-intelligence application. The machine learning model is focused on classification, prediction, pattern search, trend search, data cluster search, data mining, and/or knowledge discovery. The method includes automatically creating a set of attributes for the machine learning model and/or the artificial-intelligence application that is usable on the substantial dataset. In addition, the method includes efficiently generating a data representation for the machine learning model and/or the artificial-intelligence application that is usable on the substantial dataset.

### FIELD OF TECHNOLOGY

This disclosure relates generally to the field of utilization of large amounts of data to train artificial intelligence models or applications, and, more particularly, to a method and system to automatically generate attributes based on semantic categorization of large datasets in artificial intelligence models and/or applications.

### BACKGROUND

A machine learning model may be a mathematical representation and/or an algorithm that is trained on data to make predictions (or decisions) without being explicitly programmed. The machine learning model may be designed to learn patterns and relationships from input data, which could be numerical values, text, images, and/or any other type of structured or unstructured data. During the training process, the machine meaning model may be presented with a set of labeled examples, known as the training data, and may adjust its internal parameters to find patterns and correlations in the data.

As part of the training process, certain “attributes” may be learned by the machine in order to identify potentially useful data from a given dataset. Attributes may be characteristics of the given data, and can come in many forms including quantitative and qualitative. For example, if one is using machine learning to organize a photo album, an attribute could be a certain threshold of red pixels. Machine learning models can theoretically use an infinite number of attributes to organize and eventually data, but unfortunately, not all of these attributes are useful, and in fact, some can detriment the machine learning model. If the model is using poorly devised or poorly structured attributes, inconsistencies and malfunctions within the model can occur.

Sometimes, attributes may be calculated using organized data prior to the use of the machine learning, but this process can be time consuming. For example, if a machine learning model uses a thousand attributes, each of those thousand has to be calculated and input into the model. Furthermore, these attributes may apply to one mode of data, e.g., one attribute may work for identifying the word “consumer” in a photo while another attribute may work for finding the word “consumer” in a dataset. When there is a narrow modal scope of attributes, thousands of attributes may be inserted into a model, but a fraction of the attributes may actually be useful, and identifying useful attributes can be equally as time consuming as creating them. This can lead to lost time, loss of revenue, inefficient memory allocation, slower speeds of machine learning models, and other undesirable characteristics.

### SUMMARY

Disclosed is a method and system to automatically generate attributes based on semantic categorization of large datasets in artificial intelligence models and/or applications.

In one aspect, a method of automatic representation of data may include organizing a substantial dataset in a manner through which it may serve as an input to a machine learning model and/or an artificial-intelligence application. The machine learning model may be focused on a classification, a prediction, a pattern search, a trend search, a data cluster search, a data mining, and/or a knowledge discovery. The method may include automatically creating a set of attributes for the machine learning model and/or the artificial-intelligence application that may be usable on the substantial dataset. In addition, the method may include efficiently generating a data representation for the machine learning model and/or the artificial-intelligence application that may be usable on the substantial dataset.

The method may include creating additional sets of attributes to be used by an ensemble of machine learning models whereby each single set of attributes may be a basis of a single machine learning model in the ensemble. The method may compare data objects by means of whether they have same combinations of attribute values on each single set of attributes. The method may include computing a similarity score between the objects as an amount of the sets of attributes for which the corresponding combinations of attribute values are the same. The method may form a query-by-example artificial-intelligence application through the comparing data objects by means of whether they have the same combinations of attribute values on each single set of attributes and/or computing the similarity score between the objects as the amount of the sets of attributes for which the corresponding combinations of attribute values are the same.

The method may further include using the query-by-example artificial intelligence application as a component of a diagnostic application of the machine learning model which searches for similar historical data objects to a currently diagnosed data objects and/or a data labeling application which searches for a maximally similar and/or a maximally diverse data objects to be labeled.

The method may include collecting a set of parameters that may be applied to the substantial data in an information library. The information library may be a repository of attribute specifications. The attribute specifications may have hyperparameters that may be usable to compute various alternative versions of the attributes. The alternative versions of the attributes may have different practical properties that make some of them more useful for any one of training the accurate machine learning models and/or designing an efficient artificial intelligence application.

The method may further include using an information pipeline module to compute a set of data transformations and/or perform calculations of the attribute values. The method may apply the attribute specifications from the information library on the substantial data and/or storing result data as in an efficient data storage. The computed attribute values may be storable in a compressed format to decrease required storage size.

Furthermore, the method may include interpreting a description of the hyper parameter space when applying the method to create the automatic representation of data suitable for any of the machine learning models, intelligent algorithms, and/or artificial intelligence applications. In addition, the method may include interacting with a user of the machine learning model through an information-finder module.

The user may be asked to define a type of the substantial data, a location where the substantial data, and/or attribution specifications are stored, an upload method, and/or a semantic type of the substantial data. The method may determine which type of data transformation to use when identifying the space of parameters based on the semantic type when the description is interpreted.

The method may optimize the automatic representation in a compute-efficient manner that may be suitable for the machine learning model based on the semantic type using the description of the hyper parameter space. The method may estimate whether a particular attribute specification is useful for a particular substantial dataset based on the semantic type and/or using the description of the hyper parameter space. The method may include learning a set of attributes in the substantial data that may be important by applying an attribute selection/extraction method, and using the set of identified important attributes to make predictions on new data.

The substantial dataset may be an unstructured data that is so voluminous that traditional data processing methods are unable to discreetly organize the data in a structured schema. The method may further include analyzing the substantial dataset computationally to reveal at least one pattern, trend, and/or association relating to a human behavior and/or a human-computer interaction.

The method may include sampling randomly a space of possible hyper parameter settings whereby the sampled setting may become a means to compute corresponding attributes and/or evaluate them through a random-sampling application. In addition, the method may include applying intelligence to the random sampling through a stratified sampling technique, a systematic sampling, a cluster sampling, a probability proportional to size sampling, and/or an adaptive sampling method.

The method may include forming a data representation in a form of a tensor, storing the tensor in a single cell of the substantial database, conveniently using the tensor in a machine learning method by retrieving the data from the single cell of the substantial database, and/or fitting the machine learning model using the tensor. The tensor may be a multi-dimensional array and/or a mathematical object to generalize scalars, vectors, and/or matrices. The substantial dataset may include a set of columns with any one of integers floats, characters, strings, and/or categories.

Furthermore, the method may evaluate a chosen attribute using a heuristic evaluation approach. The heuristic approaches may include an entropy of a decision class conditioned by the chosen attribute to be evaluated, an accuracy of the machine learning model trained on the representation extended by the chosen attribute, and/or creating a score for the chosen attribute. The method may permit an external domain expert to assist in fine-tuning the automatic representation of data.

Additionally, the method may include assuring a diversity of hyper parameter settings corresponding to the chosen attributes while constructing the set of attributes and may define a metric over a space of hyperparameters to indicate which settings any of closer to each other or distant from each other. The method may ensure a complementary mix of sources of information required for calculating the set of attributes when a multimodal data may include any of a set of images, videos, audio, and/or text data.

Even further, the method may include maintaining a heatmap of hyper parameter settings for which corresponding attributes have been already examined, whereby that heatmap may register which attributes were evaluated as good and/or which as bad during an iterative process of selecting attributes and/or adding best ones to the set of attributes. Iteration of the heatmap may be additionally used during a process of random selection of the hyperparameters settings whereby the settings which are closer based on a metric over the space of possible hyper parameter settings to the good ones and/or more distant from the bad ones examined before.

In another aspect, a method may include selecting for a chosen attribute for a data organization using machine learning by ingesting a dataset. The dataset may be any one of an unstructured data, a multimodal data, and an original data. In addition, the method may include selecting at least one parameter and at least one specification using an information pipeline module for the chosen attribute. The at least one specification may be any one of a representations specification, a transformation specification, and/or a modeling specification. The method may include generating a result data from the dataset using at least one parameter and the at least one specification. The method may automatically identify an optimal attribute using at least one parameter and at least one specification. The method may further include evaluating a data attribute using a predefined quality measure, such as a mutual information function, a gini impurity, a class discernibility measure, and/or others. Additionally, the method may include selecting an additional attribute from the possible attribute specification and parameter tuples based on the evaluation using a predefined quality measure. Furthermore, the method may include updating the result data usable in the machine learning model with the additional attribute.

In yet another aspect, a method of automatic representation of data may include automatically creating a set of attributes for a machine learning model and/or an artificial-intelligence application that is usable on the substantial dataset. The method may further include efficiently generating a data representation for the machine learning model and/or the artificial-intelligence application that may be usable on the substantial dataset. In addition, the method may include collecting a set of parameters that may be applied to the substantial data in an information library and may use an information pipeline module to compute a set of data transformations and/or perform calculations on the attributes. Furthermore, the method may include applying the attribute specifications from the information library on the substantial data and storing a result data as in the machine learning model.

### BRIEF DESCRIPTION OF THE DRAWINGS

The embodiments of this invention are illustrated by way of example and not limitation in the figures of the accompanying drawings, in which like references indicate similar elements and in which:

FIG. 1 is an interaction view of a communication path between an information finder module and an information library through an information pipeline module that utilizes repository and methods, according to one embodiment.

FIG. 2 is an operational view of the information pipeline module using a parametrized specifications selection module and a feature evaluation module of the information pipeline module 108, according to one embodiment.

FIG. 3 is a process flow in which additional sets of attributes to be used by at least one of an ensemble of machine learning models may be created, according to one embodiment of the interaction view of FIG. 1.

FIG. 4 is a process flow diagram in which a query-by-example artificial intelligence application may be utilized, according to one embodiment. In operation, data objects may be compared by means of whether they have the same combinations of attribute values on each single set of attributes of the interaction view of FIG. 1.

FIG. 5 is a process flow diagram in which the type of data transformation to use when identifying the space of parameters based on the semantic type when the description is interpreted may be determined, according to one embodiment of the interaction view of FIG. 1.

FIG. 6 is a process flow diagram in which the set of identified important attributes may be used to make predictions on new data, according to one embodiment of the interaction view of FIG. 1.

FIG. 7 is a process flow diagram in which the tensor may be used to fit the machine learning model, according to one embodiment of the interaction view of FIG. 1.

FIG. 8 is a process flow diagram in which a heatmap of hyper parameter settings may be maintained, according to one embodiment of the interaction view of FIG. 1.

FIG. 9 is a process flow in which the result data usable in the machine learning model may be updated with the additional attribute, according to one embodiment. In operation, a chosen attribute for a data organization may be selected for using machine learning by ingesting a dataset of the interaction view of FIG. 1.

FIG. 10 is a process flow in which the attribute specifications from the component may be applied on the substantial dataset and storing a result data as in the machine learning mode, according to one embodiment of the interaction view of FIG. 1.

FIG. 11 is a process flow in which the automatic representation may be optimized in a compute efficient manner that is suitable for the machine learning model based on the semantic type using the description of the hyper parameter, according to one embodiment of the interaction view of FIG. 1.

FIG. 12 is an interaction view of the substantial dataset and set of attributes being input into the machine learning models, intelligent algorithms, and/or artificial intelligence application, according to one embodiment of the interaction view of FIG. 1.

FIG. 13 is an expanded view of the artificial intelligence application wherein a query-by-example artificial-intelligence application is created by comparing a diagnostic application and a data labeling application by means of whether they have the same combinations of attribute values on each single set of attributes and/or computing the similarity score between the objects, according to one embodiment of the interaction view of FIG. 1.

Other features of the present embodiments will be apparent from the accompanying drawings and from the detailed description that follows, according to one embodiment.

### DETAILED DESCRIPTION

Disclosed is a method and system to automatically generate attributes based on semantic categorization of large datasets in artificial intelligence models and/or applications.

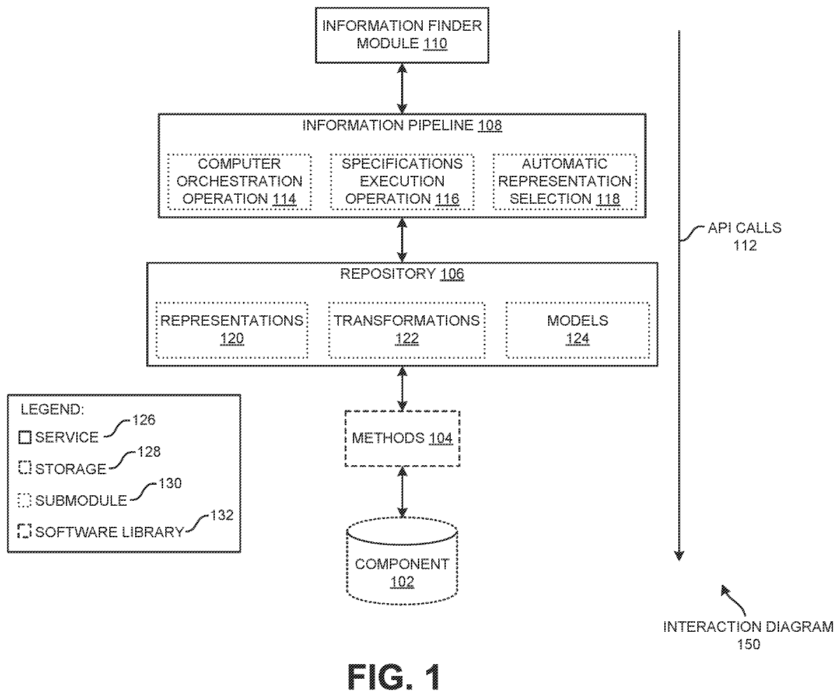

FIG. 1 is an interaction view 150 of a communication path between an information finder module 110 and an component 102 through an information pipeline module 108 that utilizes repository 106 and methods 104, according to one embodiment. FIG. 1 describes a component 102, a method(s) 104, a repository 106, an information pipeline 108, an information finder module 110, a API call(s) 112, a computer orchestration operation 114, a specifications execution operation 116, an automatic representation selection operation 118, a representation(s) 120, a transformation(s) 122, a model(s) 124, a legend identifying services 126, a storage 128, a submodules 130, and a software library 132.

The component 102 may be a storage layer of automatic generation of attributes system responsible for storing tabular representations 120 available in the system (which may include the intermediate memory-only storage and partially materialized storage). The method(s) 104 may be a library of efficient algorithms with higher level API for the set of performance-critical operations over component 102. The repository 106 may be a repository of features and machine learning models specifications (which also may be known as recipes).

The information pipeline 108 may be a layer that may be responsible for calculating the contents (e.g. calculating the values of attributes) corresponding to tabular data representations of big, unstructured, or multimodal data repositories. The information finder module 110 may have data and algorithms move to the information pipeline 108 via the API calls 112 and/or be fetched from the user remote storage according to data ingestion specification. The API call(s) 112 may be a set of rules and protocols that allows different software applications to communicate and interact with each other.

The computer orchestration operation 114 may be a process of managing and coordinating the execution of computational tasks or processes in a distributed computing environment. The specifications execution operation 116 may execute the objectives, constraints, and/or expected outcomes for the machine learning generated attribute(s) system. The automatic representation selection operation 118 may create tabular representations of data or attributes.

The representation(s) 120 may be specifications that may be responsible for new features creation that may be on exactly the same level of aggregation as original data. The transformation(s) 122 may be recipes that change the granulation level of input data objects/rows, which may be by creating new objects from existing by aggregation of multiple objects or splitting of one object to several sub-objects. The model(s) 124 may be specifications for training machine learning models intended to solve one machine learning tasks available in the machine learning attribute generation system.

A legend described at the bottom left in FIG. 1 shows services 116, storage 118, and software library 104 are part of the interaction diagram 150. The legend describes service 126 which may describe services of the interaction view 150, and which may include services found in the information finder module 110, the information pipeline 108, and/or the repository 106. The legend in FIG. 1 also describes storage 128 may be information stored in the database of the component 102. In addition, submodule 130 described in the legend of FIG. 1 may include the computation orchestration 114, the specifications execution 116, the automatic representation selection operation 118, the representations 120, the transformations 122, and/or the models 124. The software library 132 in the legend of FIG. 1 may include methods 104.

The information finder module 110 may be a frontend layer that may allow users to interact with the system. The information finder module 110 may work as a user oriented interface for other components of the system. The information finder module 110 may allow users to model the available data and important relations between fragments of the data, choose repository 106 features specifications that may be used to transform their data repository into tabular representation; setup ingestion of the data into the system, and configure and monitor the tabular representation computation with pipelines.

The information pipeline 108 may further be responsible for on demand and periodic data transformation into desired tabular representation according to configurations that may be defined by the information finder module 110. The information pipeline 108 may comprise submodules 130 including but not limited to the computation orchestration 114, the specifications execution 116, and/or the automatic representation selection operation 118. It may involve organizing, scheduling, and overseeing the execution of individual computational units to achieve a specific goal and/or outcome.

Specifications for new features may be retrieved from the repository 106 via the API calls 112 and may be used to process the data. These specifications may comprise submodules 130 including but not limited to the representation(s) 120, the transformation(s) 122, and/or the model(s) 124, specifications may be used to create tabular representations manually selected by a user or automatically by automatic representation selection pipelines. Those optimized algorithms may take advantage of underlying columnar data format, efficient extension of data with new columns, and advanced data summaries computed for chunks of data, and may leverage low level component 102 API. They may be used in both information pipeline 108 and repository 106 recipes to obtain performance that may be required for big data processing. Those algorithms among the others may allow for: retrieval of similar examples via specialized index, decision reducts computation, and/or data matching. There may be a consistent and efficient approach for storing both tensors and standard tabular values which may allow it to maintain the data in a structured data representation suitable for analytical, business intelligence and machine learning applications.

Further in FIG. 1 API calls 112 might be done only from each of the modules to components below, i.e. information finder 110 may make API calls to information pipeline 108, repository 106, software library 104 and storage 102; information pipeline 108 may make API calls to repository 106, software library 104 and storage 102; specifications from repository 106 may make API calls to software library 104 and storage 102; methods from software library 104 may make API calls to storage 102. FIG. 1 may further comprise a legend describing the service(s) 126, the storage(s) 128, the submodule(s) 130, and the software library(s) 132.

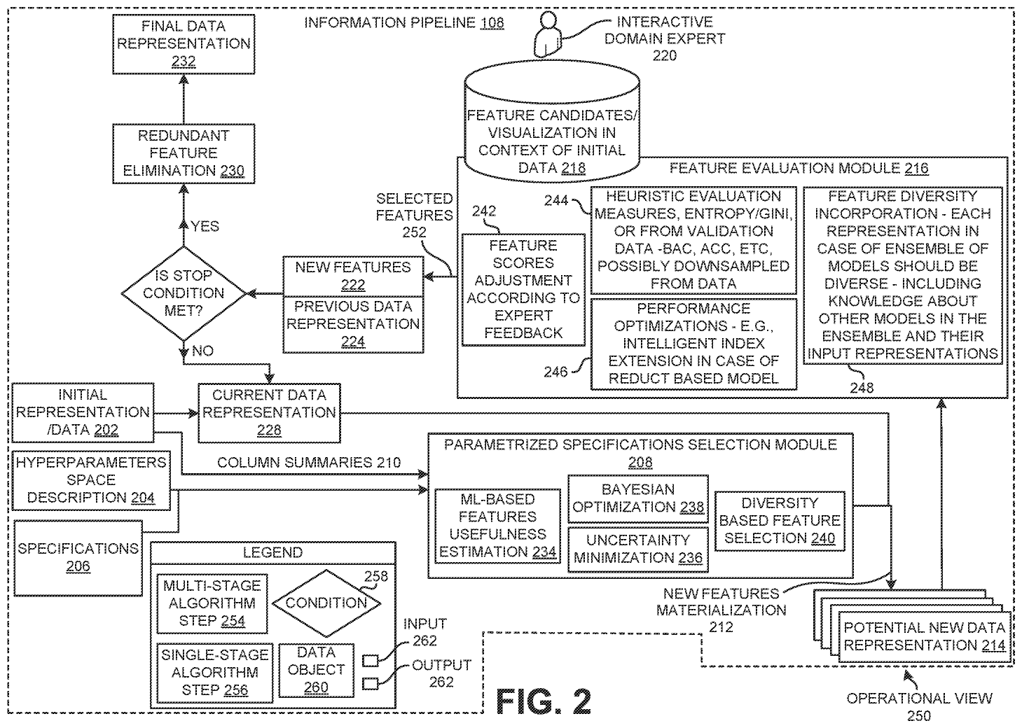

FIG. 2 is an operational view 250 of the information pipeline module 108 of FIG. 1 using a parametrized specifications selection module 208 and a feature evaluation module 216 of the information pipeline module 108, according to one embodiment. FIG. 2 shows a initial representation/data 202, a hyperparameters space description 204, a specification(s) 206, a module 208, a column summaries 210, a new features materialization 212, a potential new data representation(s) 214, a feature evaluation module 216, a view of feature candidates/visualization in context of initial data 218, an interactive domain expert 220, a new features 222, a previous data representation 224, a stop condition 226, a current data representation 228, a redundant feature elimination 230, a final data representation 232, a machine learning-based features usefulness estimation 234, a uncertainty minimization 236, a bayesian optimization 238, a diversity based feature selection 240, a feature scores adjustment according to expert feedback 242, a heuristic evaluation measures 244, a performance optimizations 246, a feature diversity incorporation 248, a selected features 252, a multi-stage algorithm step symbol 254, a single-stage algorithm step symbol 256, a condition symbol 258, a data object symbol 260, a input symbol 262 and a output symbol 264.

The initial representation/data 202 may be images, logs, videos, timeseries, texts, data tables, map data. The hyperparameters space description 204 may be the size of the aggregation window for time series and/or may be hyperparameters of a machine learning model like number of layers in a neural network and/or the length in metric space that two objects should be considered near each other. The specifications 206 may be the code for making predictions with pre a trained machine learning model, taking windowed mean from time series data and may determine if the given point on the map is near to the avalanche area.

The module 208 may be one or combination of: the machine learning-based features usefulness estimation 234, the uncertainty minimization 236, the bayesian optimization 238, and the diversity based feature selection 240 to create the new features materialization 212, which may then give rise to the new potential data representation 214. The column summaries 210 may be representations of semantic type of the column or a learned embedding describing the data in the column. The new features materialization 212 may refer to creating new attributes such as for example the aggregate values (such as average, min, max, trend), computed over some parameterized time or space ranges, and may comprise more advanced features which may be the outputs of some partial machine learning models and/or data-type-specific semantic features such as for example features characterizing the audio recordings. Furthermore, the features may characterize the shapes of objects on images and dynamics of objects in videos, the arrays of objects identified at some images, videos or texts, etc., as well as hierarchical combinations and concatenations of those; whereby the new attributes may first temporarily materialized for the evaluation purposes and then may be added to the constructed sets of attributes if that evaluation is successful.

The new potential data representation 214 may take a form of the previous data representation 224 with the added new attributes as data columns or the ensemble of multiple data representations whereby each of them may correspond to different new attributes that were added to the previous data representations 224; the attributes may have the values taking a form of for example integers, floats, decimals, strings, and/or tensors of all of those, with some values possible missing. The feature evaluation module 216 may be evaluating randomly and/or intelligently selected and materialized attributes by means of different criteria and its final outcomes may be based on the combinations of those criteria.

The feature candidates 218 may be based on at least one of the visualization of the hyperparameters settings corresponding to particular features, the visualization of examples of specific values that particular features take on the data objects, and/or the visualization of the feature importance rankings computed based on the intermediate machine learning models learnt underneath for the given set of features extended by the new feature candidates. The interactive domain expert 220 may be a subject matter expert who evaluates the feature candidates according to his or her experience about the given domain of application and the given characteristics of original data sources, a data scientist who looks at the features from the perspective of their usability in further stages of machine learning, a business analyst who is interested in selecting features which are maximally interpretable for the purpose of business reporting and business decision making, or a data or enterprise system administrator who evaluates the features from the perspective of the total cost of their calculation.

The new features 222 may be added to the previous data representations 224 by materializing the feature values for the whole underlying original data and adding the materialized data column to the data table which corresponds to the set of features, and/or adding the new features in a virtual form, which may mean only memorizing their specification but without materializing the corresponding data columns. The new features 222 may then be applied to the previous data representation 224 which may then be evaluated for the at least one stop condition 226. The previous data representation 224 may be any data not yet processed and may be amended by extending it with the new features.

The at least one stop condition 226 may refer to a sufficient level obtained while evaluating new features in combination with the previous features in the phase of feature evaluation, to the sufficient level of coverage of the space of possible hyperparameter settings by the sampled settings corresponding to the features that were successfully added to the set of features, and/or the cost and computational constraints such as the maximum time of computations or the maximum cost of computational resources that were used so far. If a stop condition 226 is not met, the current data representation is then reapplied to the feature evaluation module 216 wherein selected features 252 are rematerialized.

The current data representation 228 may refer to the format and/or structure in which data is represented and/or encoded for processing by AI algorithms and may encompass how data is organized, transformed, and/or prepared to be ingested by AI models or systems. The redundant feature elimination 230 may be based on applying the same or different heuristic measures as in the heuristic evaluation measures 244 and may verify whether their scores are significantly different before and after removing the given feature (tested whether it is redundant or not) from the set of features. The final data representation 232 may be the single set of features or an ensemble of sets of features. The machine learning-based features usefulness estimation 234 may be a machine learning model predicting expected accuracy gain on validation dataset with representation extended by a particular attribute.

The uncertainty minimization 236 may be a variance of the expected accuracy gain prediction. The Bayesian optimization 238 may be the Expected Improvement exploration strategy. The diversity based feature selection 240 may be an iterative process based on cosine distance between attribute specifications' representations or a distance defined over the ranges of possible settings of hyperparameters of those specifications. The feature scores adjustment according to expert feedback 242 may influence the algorithms' decisions about adding or not adding particular features to the set of attributes. The heuristic evaluation measures 244 may be criteria or guidelines used to assess the usability and user experience of a system, interface, or product based on heuristics and may be general principles or rules of thumb that help identify potential usability issues or areas for improvement. The heuristic evaluation measures 244 may include information gain or gini index, and/or the wrapper-based measures whereby internal machine learning models are trained using the corresponding attributes and the evaluation of these attributes is based on the accuracy of these models, according to one embodiment.

The performance optimizations 246 may be based on the maintenance of in-memory index reflecting how the given set of features (including the features under evaluation) may partition the data, which may be computationally efficient to derive such heuristic evaluation measures as information gain or gini index based on that partition index. The feature diversity incorporation 248 may be based on at least one of preferring to select features that are computed using different data sources, components or modalities, and/or preferring to select features that are based on different specific settings of hyperparameters that may be used during their derivation.

The selected features 252 may be resulting from any of the aforementioned methods that may be applied separately or in combination with each other. Furthermore, the interactive domain expert 220 can view feature candidates 218 which may aid the feature selection module 216 in producing selected features 252. The potential new data representation 214 is input into the feature evaluation module 216 wherein any one of the feature scores adjustment according to expert feedback 242, the heuristic evaluation measures 244, the performance optimizations 246, and/or the feature diversity incorporation 248 are applied to create selected features 252. If a stop condition 226 is met, then redundant feature elimination 230 may occur, which may result in a final data representation 232.

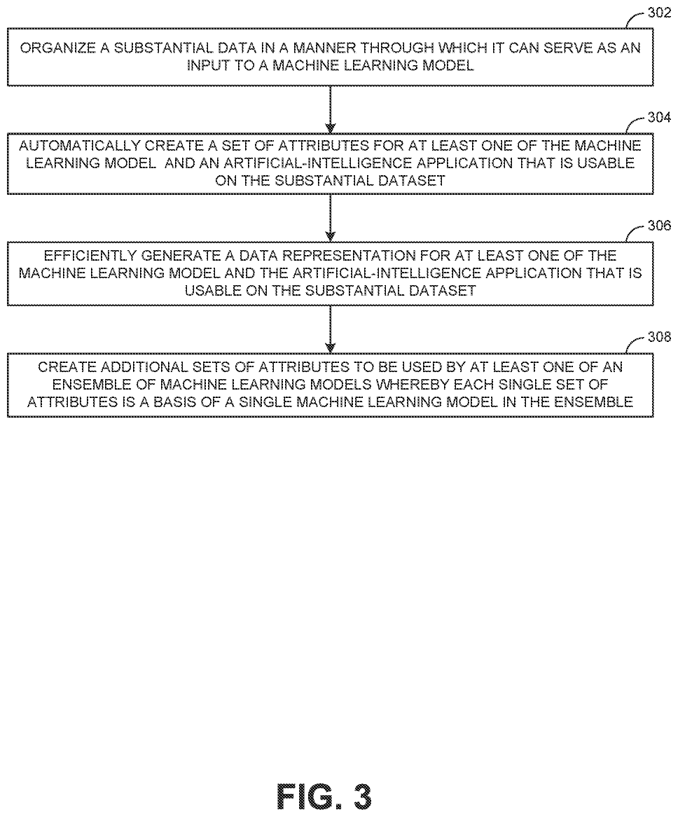

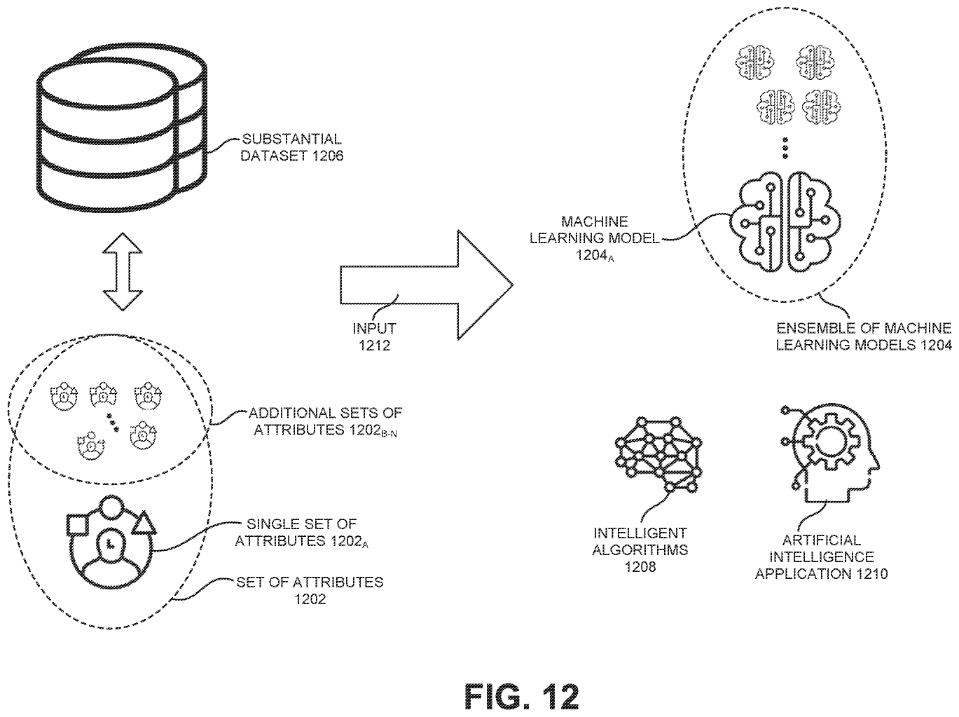

FIG. 3 is a process flow diagram in which additional sets of attributes 1202 B-N to be used by at least one of an ensemble of machine learning models 1204 may be created, according to one embodiment of the interaction view 150 of FIG. 1. FIG. 3 is best understood in conjunction with the diagram in FIG. 12. In operation 302, a substantial dataset 1206 may be organized in a manner through which it can serve as an input 1212 to a machine learning model 1204A as shown in FIG. 12. In operation 304, a set of attributes for at least one of the machine learning model 1204A and an artificial-intelligence application 1206 that is usable on the substantial dataset 1206 may be created. In operation 306, a data representation for at least one of the machine learning model 1204A and the artificial-intelligence application 1206 that is usable on the substantial dataset 1206 may be efficiently generated. In operation 308, additional sets of attributes 1202 B-N to be used by at least one of an ensemble of machine learning models 1204 whereby each single set of attributes 1202A is a basis of a single machine learning model 1204A in the ensemble may be created.

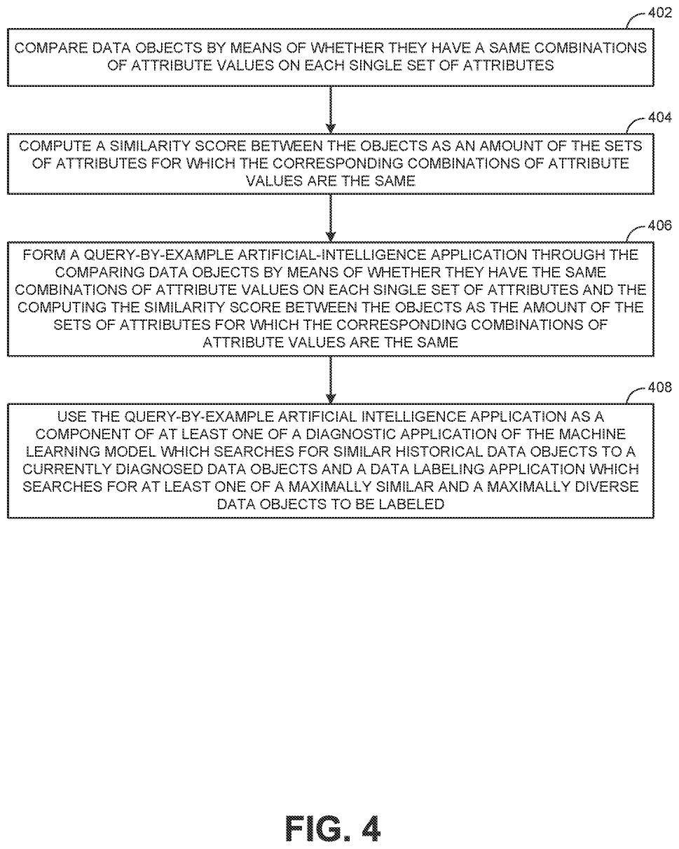

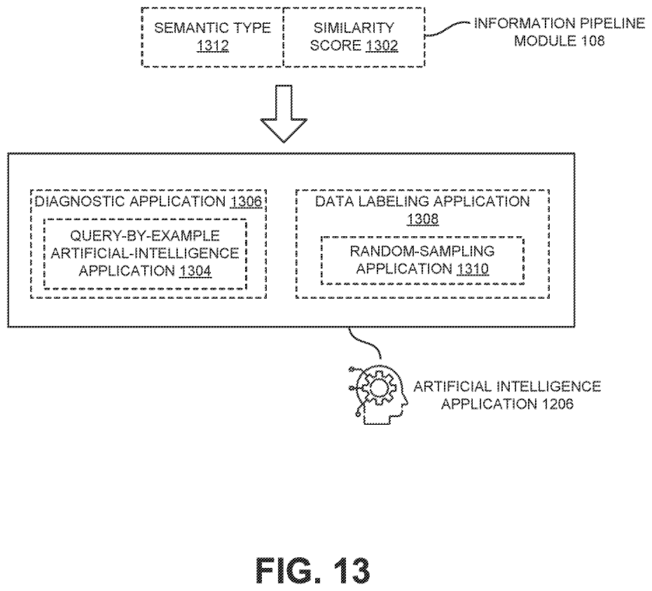

FIG. 4 is a process flow diagram in which a query-by-example artificial intelligence application may be utilized, according to one embodiment. In operation 402, data objects may be compared by means of whether they have the same combinations of attribute values on each single set of attributes 1202A of the interaction view 150 of FIG. 1. FIG. 4 is best understood in conjunction with the diagram in FIG. 13. In operation 404, a similarity score 1302 between the objects as an amount of the sets of attributes 1202 for which the corresponding combinations of attribute values are the same may be computed. In operation 406, a query-by-example artificial-intelligence application 1304 may be formed through the comparing data objects by means of whether they have the same combinations of attribute values on each single set of attributes 1202A and the computing the similarity score 1302 between the objects as the amount of the sets of attributes 1202 for which the corresponding combinations of attribute values are the same. In operation 408, the query-by-example artificial intelligence application 1304 may be used as a component 102 of at least one of a diagnostic application 1306 of the machine learning model 1204A which searches for similar historical data objects to a currently diagnosed data objects and a data labeling application 1308 which searches for at least one of a maximally similar and a maximally diverse data objects to be labeled.

In the context of various embodiments of FIGS. 1-13, the terms “parameter” and “attribute” may be used to refer to different aspects of the training process. For example, a parameter may refer to an internal variable of a model that is learned during the training process. The parameter in various embodiments may capture the relationships between the input features and the target variable. For example, in a linear regression model, the parameters may be the coefficients that multiply the input features. These coefficients may be adjusted during training to minimize the difference between the predicted outputs and the true outputs. Parameters may be optimized using algorithms such as gradient descent.

In other embodiments of FIGS. 1-13, an attribute, on the other hand, may refer to a characteristic or property of the input data that is used as an input feature for training a machine learning model. It may represent the different dimensions or characteristics of the data that are relevant to the prediction task. For example, in a dataset of houses, the attributes could include the number of bedrooms, the size of the living area, the location, and so on. Each attribute may provide information that helps the model learn patterns and make predictions.

To summarize, parameters may be internal variables of a model that are learned during training, while attributes may be characteristics or properties of the input data that are used as features for training the model. Parameters may capture the relationships between the attributes and the target variable, enabling the model to make predictions based on new input data, according to one embodiment.

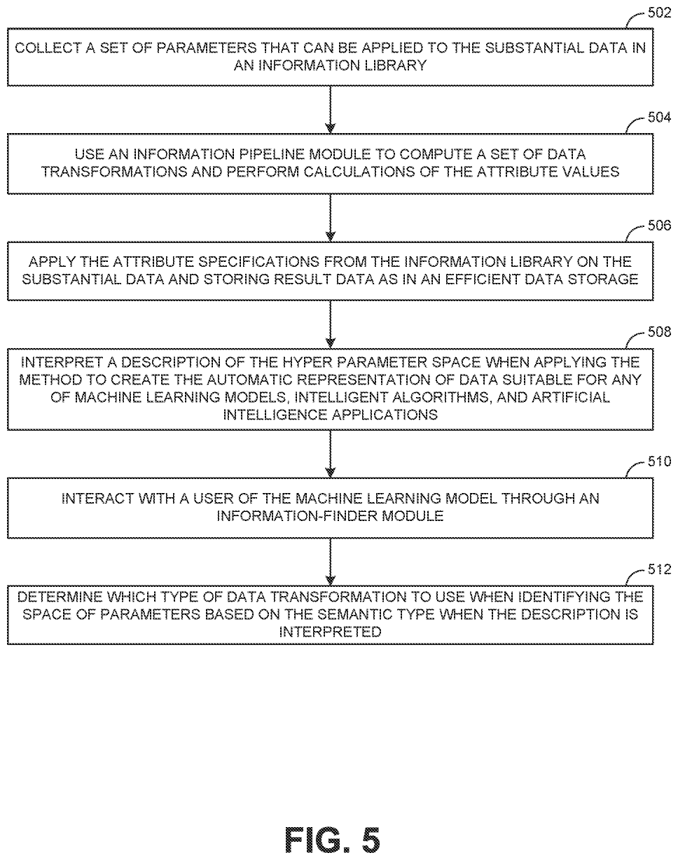

Turning to parameters, FIG. 5 is a process flow diagram in which the type of data transformation to use when identifying the space of parameters based on the semantic type 1310 when the description is interpreted may be determined, according to one embodiment of the interaction view 150 of FIG. 1. In operation 502, a set of parameters that can be applied to the substantial dataset 1206 in an component 102 may be collected. In operation 504, an information pipeline module 108 may be used to compute a set of data transformations and perform calculations of the attribute values. In operation 506, the attribute specifications 116 from the component 102 may be applied on the substantial dataset 1206 and storing result data as in an efficient data storage. In operation 508, a description of the hyper parameter space 204 may be interpreted when applying the method to create the automatic representation of data suitable for any of machine learning models 1204, intelligent algorithm(s) 1208, and artificial intelligence application(s) 1206. In operation 510, a user of the machine learning model 1204A may be interacted with through an information-finder module 110. In operation 512, which type of data transformation to use when identifying the space of parameters based on the semantic type 1310 when the description is interpreted may be determined.

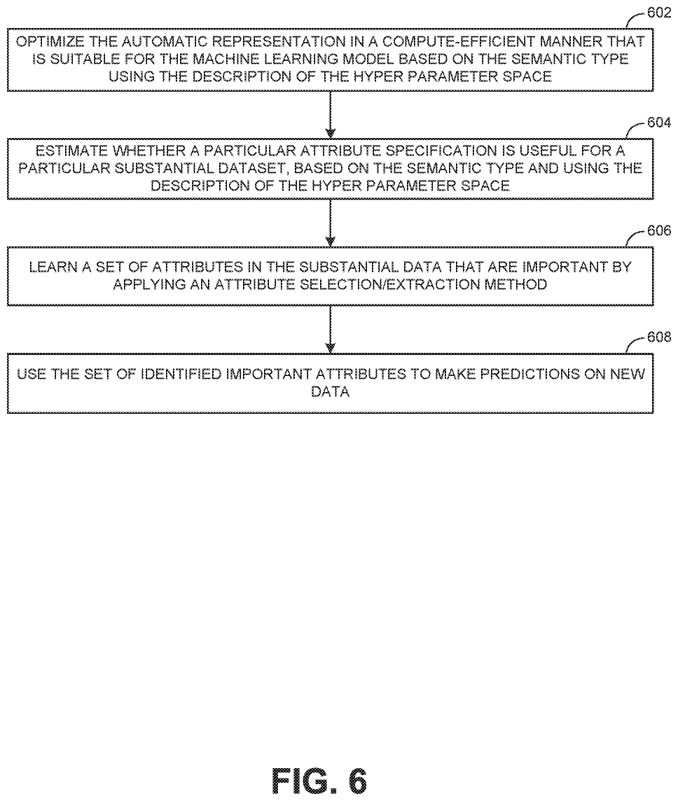

FIG. 6 is a process flow diagram in which the set of identified important attributes may be used to make predictions on new data, according to one embodiment of the interaction view 150 of FIG. 1. In operation 602, The automatic representation may be optimized in a compute-efficient manner that is suitable for the machine learning model 1204A based on the semantic type 1310 using the description of the hyper parameter space 204. In operation 604, it may be estimated whether a particular attribute specification is useful for a particular substantial dataset 1206, based on the semantic type 1310 and using the description of the hyper parameter space 204. In operation 606, a set of attributes in the substantial dataset 1206 that are important may be learned by applying an attribute selection/extraction method (as described in the operations of the information pipeline in 108 in FIGS. 1-2). In operation 608, the set of identified important attributes may be used to make predictions on new data.

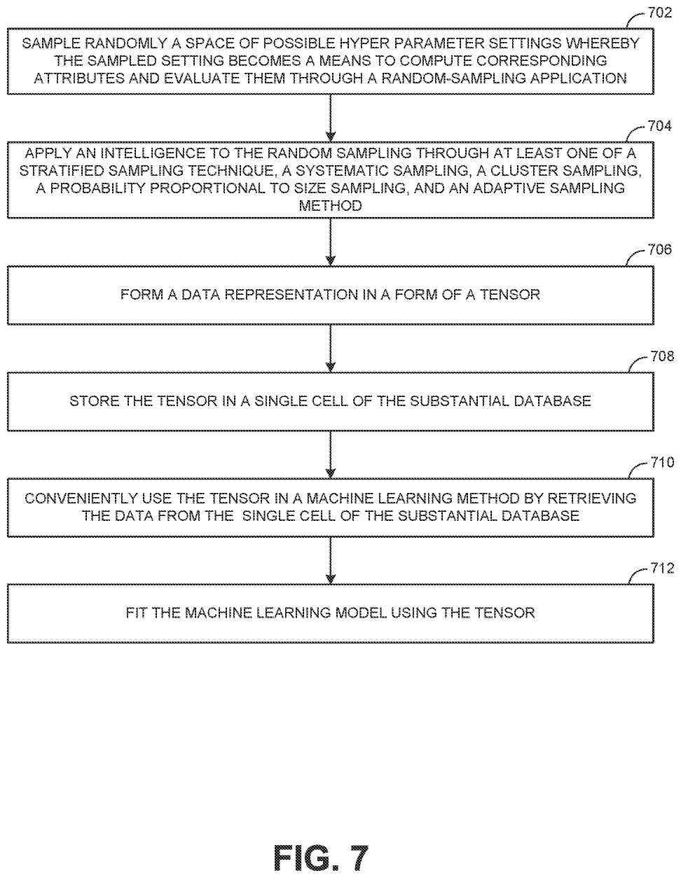

FIG. 7 is a process flow diagram in which the tensor may be used to fit the machine learning model 1204A, according to one embodiment of the interaction view 150 of FIG. 1. In operation 702, a space of possible hyper parameter settings may be randomly sampled whereby the sampled setting becomes a means to compute corresponding attributes (e.g., of the set of attributes 1202) and evaluate them through a random-sampling application 1310. In operation 704, an intelligence may be applied to the random sampling through at least one of a stratified sampling technique, a systematic sampling, a cluster sampling, a probability proportional to size sampling, and an adaptive sampling method. In operation 706, a data representation may be formed in the form of a tensor. In operation 708, the tensor may be stored in a single cell of the substantial database. In operation 710, the tensor may be conveniently used in a machine learning method by retrieving the data from the single cell of the substantial database. In operation 712, the tensor may be used to fit the machine learning mode.

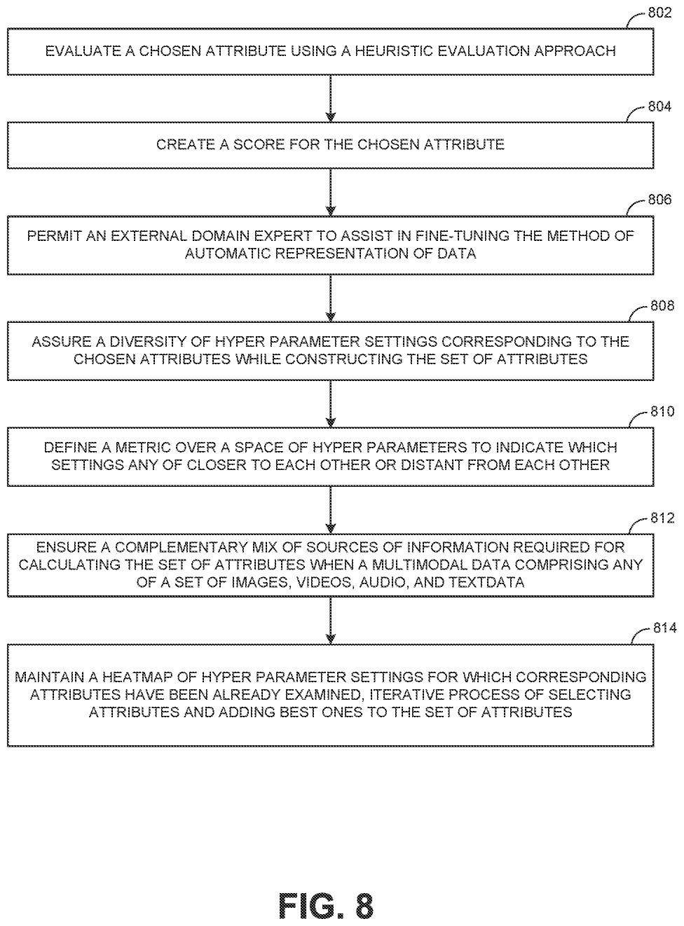

FIG. 8 is a process flow diagram in which a heatmap of hyper parameter settings may be maintained, according to one embodiment of the interaction view 150 of FIG. 1. In operation 802, a chosen attribute may be evaluated using a heuristic evaluation approach. In operation 804, a score for the chosen attribute may be created. In operation 806, an external domain expert may be permitted to assist in fine-tuning the method of automatic representation of data. In operation 808, a diversity of hyper parameter settings corresponding to the chosen attributes while constructing the set of attributes may be assured. In operation 810, a metric over a space of hyperparameters may be defined to indicate which settings are either closer to each other or distant from each other. In operation 812, a complementary mix of sources of information required for calculating the set of attributes may be ensured when a multimodal data comprising any of a set of images, videos, audio, and textdata. In operation 814, a heatmap of hyper parameter settings for which corresponding attributes have been already examined may be maintained, whereby that heatmap registers which attributes were evaluated as good and which as bad during an iterative process of selecting attributes and adding best ones to the set of attributes.

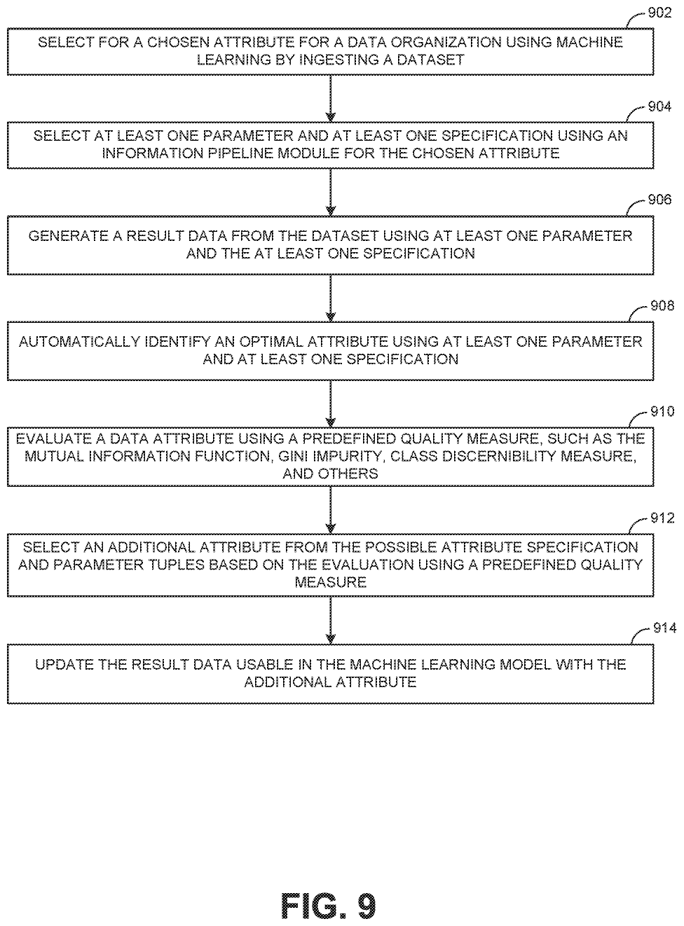

FIG. 9 is a process flow diagram in which the result data usable in the machine learning model 1204A may be updated with the additional attribute, according to one embodiment. In operation 902, a chosen attribute for a data organization may be selected for using machine learning by ingesting a dataset of the interaction view 150 of FIG. 1. In operation 904, at least one parameter and at least one specification may be selected for using an information pipeline module 108 for the chosen attribute. In operation 906, a result data may be generated from the dataset using at least one parameter and the at least one specification. In operation 908, an optimal attribute may be automatically identified using at least one parameter and at least one specification. In operation 910, a data attribute may be evaluated using a predefined quality measure, such as the mutual information function, gini impurity, class discernibility measure, and others. In operation 912, an additional attribute may be selected from the possible attribute specification and parameter tuples based on the evaluation using a predefined quality measure. In operation 914, the result data usable in the machine learning model 1204A may be updated with the additional attribute.

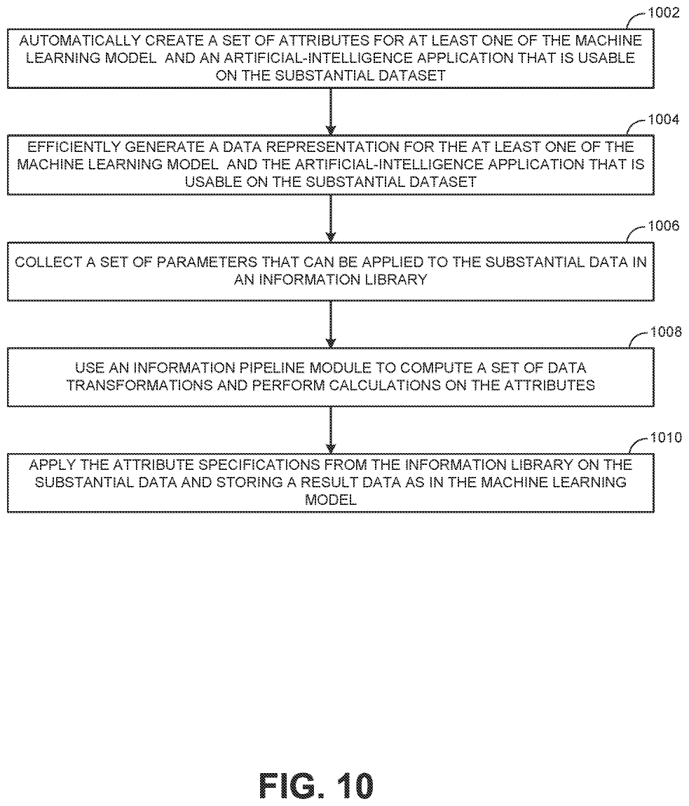

FIG. 10 is a process flow diagram in which the attribute specifications 116 from the component 102 may be applied on the substantial dataset 1206 and storing the result data as in the machine learning mode, according to one embodiment of the interaction view 150 of FIG. 1. In operation 1002, a set of attributes may be automatically created for at least one of the machine learning model 1204A and an artificial-intelligence application 1206 that is usable on the substantial dataset 1206. In operation 1004, a data representation may be efficiently generated for at least one of the machine learning model 1204A and the artificial-intelligence application 1206 that is usable on the substantial dataset 1206. In operation 1006, a set of parameters that can be applied to the substantial dataset 1206 in an component 102 may be collected. In operation 1008, an information pipeline module 108 may be used to compute a set of data transformations and perform calculations on the attributes. In operation 1010, the attribute specifications 116 from the component 102 may be applied on the substantial dataset 1206 and storing the result data as in the machine learning mode.

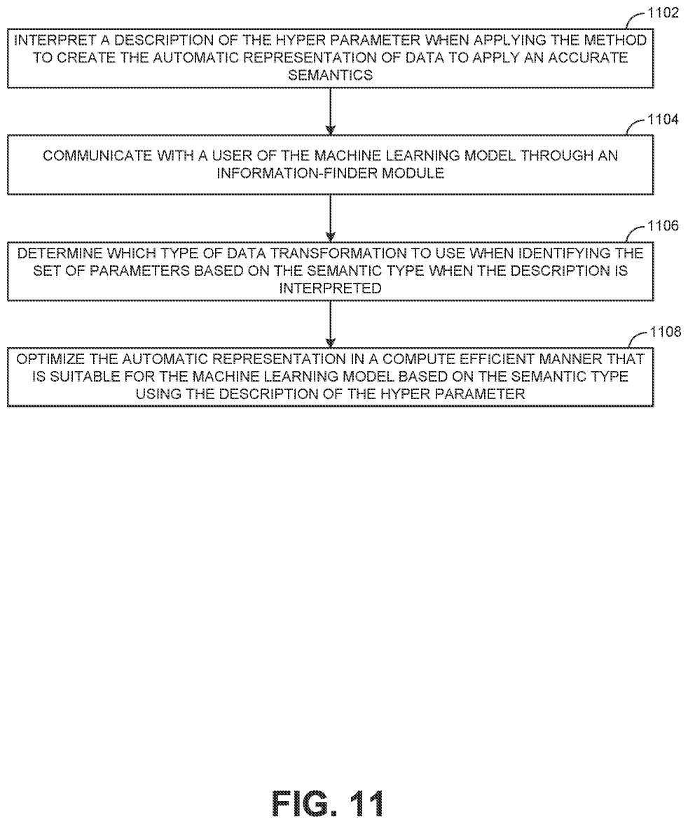

FIG. 11 is a process flow diagram in which the automatic representation may be optimized in a compute efficient manner that is suitable for the machine learning model 1204A based on the semantic type 1310 using the description of the hyper parameter, according to one embodiment of the interaction view 150 of FIG. 1. In operation 1102, a description of the hyper parameter may be interpreted when applying the method to create the automatic representation of data to apply an accurate semantics. In operation 1104, a user of the machine learning may be communicated with through an information-finder module 110. In operation 1106, A determination of which type of data transformation to use when identifying the set of parameters based on the semantic type 1310 when the description is interpreted. In operation 1108, the automatic representation may be optimized in a compute efficient manner that is suitable for the machine learning model 1204A based on the semantic type 1310 using the description of the hyper parameter.

FIG. 12 is an interaction view of the substantial dataset and set of attributes being input into the machine learning models, intelligent algorithms, and/or artificial intelligence application, according to one embodiment of the interaction view of FIG. 1. FIG. 12 shows a set of attributes 1202, a single set of attributes 1202A, a additional sets of attributes 1202B-N, a input 1212, a machine learning model 1204A, a ensemble of machine learning models 1204, a substantial dataset 1206, a intelligent algorithms 1208, and a artificial intelligence application 1210. The set of attributes 1202 may be a set of characteristics or properties of the input data that are used as features for training the model. The single set of attributes 1204A may be a distinct grouping of characteristics or properties of the input data that are used as features for training the model. The additional sets of attributes 1202B-N may be other distinct groupings of characteristics or properties of the input data that are used as features for training the model.

An input 1212 may refer to the information or data provided to an AI system for processing, such as the set of attributes 1202. The machine learning model 1204A may be any one of a linear regression model, a logistic regression model, a decision tree model, a random forests model, a support vector machines model, a neural network model, a naive bayes model, a K-nearest neighbors model, a clustering algorithms model, and/or a reinforcement learning model. The ensemble of machine learning models 1204 may refer to a technique where multiple individual models may be combined to make predictions or decisions wherein the overall performance may be improved compared to using a single model. The substantial dataset 1206 may refer to a dataset that is large enough to provide meaningful and statistically significant results for a given task or analysis and may further depend on various factors, including the complexity of the problem, the nature of the data, and the specific requirements of the analysis or model being used.

The intelligent algorithms 1208 may refer to computational procedures or techniques that exhibit intelligent behavior or mimic human-like intelligence. Intelligent algorithms 1208 may be designed to process and analyze data, make decisions, learn from experience, and/or adapt to changing circumstances. The artificial intelligence application 1210 may refer to the use of AI techniques, algorithms, and/or systems to solve specific problems and/or perform tasks that typically require human intelligence. The artificial intelligence application 1210 may leverage AI technologies to automate processes, analyze data, make decisions, and/or interact with humans and/or the environment.

FIG. 13 is an expanded view of the artificial intelligence application 1206 of the information pipeline module 108 wherein a query-by-example artificial-intelligence application 1304 is created by comparing a diagnostic application 1306 and a data labeling application 1308 by means of whether they have the same combinations of attribute values on each single set of attributes and/or computing the similarity score 1302 between the objects, according to one embodiment of the interaction view of FIG. 1. FIG. 13 shows the artificial intelligence application 1206, the similarity score 1302, the query-by-example artificial-intelligence application 1304, the diagnostic application 1306, the data labeling application 1308, the random sampling application 1310, and the semantic type 1312.

The similarity score 1302 may refer to a measure of how similar or related multiple items, instances, or entities may be to each other based on certain criteria or features and may quantify the degree of resemblance or similarity between multiple objects, which may be represented as a numerical value. The query-by-example artificial-intelligence application 1304 may refer to a system that allows users to search for or retrieve information by providing an example or prototype as a query wherein instead of using keywords or specific criteria, users may present an example that represents the desired information, and the AI system may search for similar or related items based on the provided example.

The query-by-example artificial-intelligence application 1304 may apply to an image search, a content-based recommendation, a textual content retrieval, and/or a product search. The diagnostic application 1306 may refer to the use of artificial intelligence techniques to analyze data and/or make predictions or assessments about the presence, cause, or nature of a particular condition, problem, or situation and may identify, diagnose, or classify specific issues or anomalies based on available data and patterns. The data labeling application 1308 may refer to a software tool and/or system used to annotate or label data with specific attributes or tags wherein the labeled data is used to train and develop machine learning models.

The data labeling application 1308 may provide a user interface and/or platform where human annotators or experts can interact with the data and assign appropriate labels or annotations. The annotations may include categories, classes, bounding boxes, semantic labels, sentiment scores, and/or any other relevant information depending on the specific task and/or domain. The random sampling application 1310 may refer to the use of random sampling techniques in data analysis and/or research to select a subset of data points and/or individuals from a larger population in an unbiased manner. The random sampling application 1310 may further refer to the use of random sampling techniques to select a subset of data from a larger dataset and may be a method used to obtain representative samples that accurately reflect the characteristics and distribution of the entire dataset. The random sampling application 1310 may be used in various scenarios, including training and/or testing machine learning models, data analysis, and/or statistical inference. The semantic type 1312 may refer to a categorization and/or classification of data based on its meaning or semantics. The semantic type 1312 may involve assigning labels and/or tags to data instances that may indicate their inherent meaning and/or purpose, allowing for better understanding and organization of the data. The semantic type 1312 may be Part-of-Speech (POS) Tagging, Named Entity Recognition (NER), sentiment analysis, event extraction, and/or topic modeling.

To make big data repositories useful in practice, the embodiments of FIGS. 1-13 may take care of efficient data representation of certain resources. On the one hand, there may be many approaches and technologies that help to process and store the unstructured data. On the other hand, however, if the data may be analyzed, the embodiments of FIGS. 1-13 may construct a Business Intelligence dashboard and make the data searchable. The embodiments of FIGS. 1-13 may train an artificial intelligence (AI) or machine learning (ML) model over that data, and some kind of more structured, explicit or intermediate form of the data may be necessary. In the case of data analytics, if the structured tabular form or view of the original data is created, then the data analytics tools may produce their reports based on the values of attributes of that tabular form. In the case of the searching processes, including the search engines, the tabular form may allow us to search through big data repositories using the values of its attributes treated as indices. In the case of AI/ML methods, although in theory they can work on the unstructured data, in practice, especially if the data sources are multimodal, it may be more efficient to design the unified structured representation of all modalities and then run the AI/ML algorithms with that representation treated as their input.

Certainly, the success of all the above scenarios may depend on the quality of the created tabular representations. The values of attributes may not need to be standard. They may take the form of vectors, matrices or tensors as well. What may be most important is that the way how those values reflect the original unstructured data contents may be on the one hand technically convenient and scalable and on the other hand it may allow building analytical reports, search indices and AI/ML models that may be useful and accurate in practice.

The embodiments of FIGS. 1-13 may correspond to the platform that allows for creating, maintaining and applying the structured tabular representations of big, unstructured, and multimodal data repositories, whereby the attributes corresponding to those tabular representations may have the values that may either be standard or they may take the form of tensors of standard values. According to the embodiments of FIGS. 1-13 this framework is an automatic generation of attributes system having the interaction view 150 as described in FIG. 1. The main components of the interaction view 150 of FIG. 1 may be: Repository module 106—the layer that may be responsible for storing parameterized specifications of attributes that may be derived from big, unstructured, or multimodal data repositories; Information finder module 110—the layer that may be responsible for modeling available data repositories and designing tabular data representations via specifications from repository module 106; Information pipeline 108—the layer that may be responsible for calculating the contents (e.g. calculating the values of attributes) corresponding to tabular data representations of big, unstructured, or multimodal data repositories; Component 102—the layer that may be responsible for storing (including the intermediate memory-only storage and partially materialized storage) the contents of tabular data representations; and Methods 104—the layer that may be responsible for fast operations over component 102, may take advantage of underlying columnar data format, efficient extension of data with new columns, and advanced data summaries computed for chunks of data. The component 102 may be part of an information library, according to one embodiment.

Architecture of interaction view 150 of the automatic generation of attributes system, may be from high level user-faced functionalities on top, through transformation specifications and computation orchestration to storage layer on the bottom. Components may interact with layers below via standardized API's.

Information finder module 110 may be a frontend layer that may allow users to interact with the system. It may work as a user oriented interface for other components of the system. It may allow users to: model the available data and important relations between fragments of the data; choose Repository module 106 features specifications that will be used to transform their data repository into tabular representation; setup ingestion of the data into the system; configure and monitor the tabular representation computation with pipelines.

Information pipeline 108 may be the primary layer of computation orchestration in the interaction view 150 of the automatic generation of attributes system system. It may be responsible for on demand and periodic data transformation into desired tabular representation according to configurations that may be defined by the user via Information finder module 110 interface. Pipelines among the others may: retrieve data from the Component 102, use specifications from Repository module 106 to transform the data, save transformation results in Component 102. In the core of Information pipeline 108 layer may be an innovative family of AutoML pipelines for automatic representation selection. Those pipelines may utilize an infinite virtual space of possible features described via specifications 206, Methods 104 may have low level knowledge of Component 102 architecture design, and may distribute computation scheduling to efficiently compute representations for big data tasks.

Repository module 106 may be a repository of features and machine learning models specifications (which also may be known as recipes). The features specifications may be used to create tabular representations manually selected by user or automatically by automatic representation selection pipelines. Specifications may have hyperparameters that might be used to adjust their behavior and may be divided into 3 groups based on their capabilities:

Representations 120 may be specifications that may be responsible for new features creation that may be on exactly the same level of aggregation as original data, i.e. for a given feature specification exactly a constant number of new K features may be obtained that may be concatenated vertically to existing tabular representation, e.g. a prediction that may be of a pretrained machine learning model for each row of data. For some of the recipes it may be reasonable to use obtained representation without concatenating it to original data, e.g. data normalization recipe.

Transformations 122 may be recipes that change the granulation level of input data objects/rows, which may be by creating new objects from existing by aggregation of multiple objects or splitting of one object to several sub-objects, e.g. windowed transformation of time series, multiple objects detection in images. Those recipes may be a leading source of unstructured data organization into more structured tabular representation format, e.g. parse and retrieval of log fragments to appropriate tabular rows.

Models 124 may be specifications for training machine learning models intended to solve one of machine learning tasks available in interaction view 150 of the automatic generation of attributes system. Examples of machine learning tasks may be: single-label classification, regression, object detection. Models may have a learnable state that may be distilled from tabular representation of user data and may be saved for future predictive use thanks to serialization mechanism guaranteed by specification API standard. Each specification may conform to the standardized API via: serialization, deserialization, semantic typing (crucial for automatic representation learning), learning state from data (if recipe is trainable), and transforming data into new features.

Methods 104 may be a library of efficient algorithms with higher level API for the set of performance-critical operations over Component 102. Those optimized algorithms may take advantage of underlying columnar data format, efficient extension of data with new columns, and advanced data summaries computed for chunks of data, and may leverage low level Component 102 API. They may be used in both Information pipeline 108 and recipes to obtain performance that may be required for big data processing. Those algorithms among the others may allow for: retrieval of similar examples via specialized index, decision reducts computation, data matching.

Component 102 may be a storage layer of interaction view 150 of the automatic generation of attributes system system responsible for storing tabular representations available in the system (which may include the intermediate memory-only storage and partially materialized storage). There may be a consistent and efficient approach for storing both tensors and standard tabular values which may allow it to maintain the data in a structured data representation suitable for analytical, business intelligence and machine learning applications.

In an exemplary example, the automatic generation of attributes system having the interaction view 150 may have an ability to intelligently operate with the spaces of possible features. Such spaces may span by the ranges of hyperparameters, whereby setting up specific hyperparameters may yield specific features. It should be noted that the words “hyperparameters” or “parameters” may be interchangeably used in one or more embodiments.

In one embodiment of the interaction view 150 and the embodiments described in FIGS. 1-13, both parameters and hyperparameters may play important roles in defining and/or training a model, but they may serve different purposes. For example, parameters may be the internal variables of a machine learning model that may be learned during the training process. They may capture the relationships between the input features and the target variable. For example, in a linear regression model, the parameters may be the coefficients that multiply the input features. These coefficients may be adjusted during training to minimize the difference between the predicted outputs and the true outputs. Parameters may be optimized using algorithms such as gradient descent, according to various embodiments.

In other embodiments of FIGS. 1-13, hyperparameters may be external configurations and/or settings that are set before training a model. They may not learn from the data but may be chosen by the user or a machine learning engineer of the embodiments described herein. Hyperparameters may control the behavior and/or performance of the model during the training process. They may not update during training but rather set before training begins and may remain constant throughout the process. Examples of hyperparameters in the various embodiments may include the learning rate of an optimization algorithm, the number of hidden layers in a neural network, the regularization strength, and/or the number of iterations for training.

The key distinction between parameters and hyperparameters may be that parameters are learned from the training data to capture the patterns in the data, while hyperparameters may be set by the user or engineer to control the learning process and affect the model's performance. Hyperparameters may be determined through techniques such as grid search, random search, or Bayesian optimization, which may involve evaluating the model's performance with different hyperparameter values on a validation set.

In one embodiment of the interaction view 150 and the embodiments described in FIGS. 1-13, an algorithm may be intelligently sampling spaces. The embodiment of the interaction view 150 and the embodiments described in FIGS. 1-13 may iteratively sample settings of specific hyperparameters from the available ranges. Then, the features may be computed against the data in correspondence to those specific parameters and may be evaluated using different heuristic measures (those measures may be standard, such as information gain or gini index, and/or less standard). The best evaluated features may then be added to the result (what may be a set of features) and the sampling process may repeat. In comparison, the standard approach may first generate all possible features (by considering all possible settings of hyperparameters within the ranges), may create a large data table, and may then begin the feature selection process from there.

The embodiments described in FIGS. 1-13 may predict whether the methane concentration level is going to exceed a warning threshold in a given place of a coal mine. To do this, the embodiments described in FIGS. 1-13 may gather training historical data. Every data item may correspond to a given place in the mine and may correspond to a given time of measurement.

The decision attribute (sometimes also called the target variable) may represent information about what happened with the methane concentration in that place within the next five minutes. The embodiments described in FIGS. 1-13 may create the features that are potentially useful and may build a prediction model based on the history of measurements registered by the sensors in the neighborhood. The embodiments described in FIGS. 1-13 may have many of such sensors. The embodiments described in FIGS. 1-13 may register methane concentration, wind, and/or other data. The available histories of methane measurements may be long, and the embodiments described in FIGS. 1-13 may incorporate many features.

For example, the embodiments described in FIGS. 1-13 may reflect the average methane concentration level calculated within the recent 10 minutes, the recent hour, and/or the recent day. Generally, the embodiments described in FIGS. 1-13 may consider the hyperparameter range e.g.: [−1 month, 0] (meaning that the embodiments described in FIGS. 1-13 may take into account up to one month of the history of measurements). Sampling any setting in [−1 month, 0] may correspond to the creation of the feature average(t). The embodiments described in FIGS. 1-13 may generate many features by moving it through the available range [−1 month, 0].

The embodiments described in FIGS. 1-13 may sample the range [−1 month, 0] and generate the corresponding features average(t). The embodiments described in FIGS. 1-13 may want to explore the range, so it may remember (as a kind of heat map) which areas of the range have been already explored more intensively in the previous iterations of its work. And the embodiments described in FIGS. 1-13 may take it into account to let so-far-less-explored areas of the space be explored. But secondly, the embodiments described in FIGS. 1-13 may also remember which so-far-selected hyperparameter settings turned out to yield specific features which may have turned out to be evaluated as more useful by the evaluation module of the algorithm. And the embodiments described in FIGS. 1-13 may focus more on similar settings within the explored space of hyperparameters. So this way The embodiments described in FIGS. 1-13 may combine exploration with exploitation.

Although the present embodiments have been described with reference to specific example embodiments, it will be evident that various modifications and changes may be made to these embodiments without departing from the broader spirit and scope of the various embodiments.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It may be appreciated that the various systems, methods, and apparatus disclosed herein may be embodied in a machine-readable medium and/or a machine accessible medium compatible with a data processing system (e.g., a computer system), and/or may be performed in any order.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

1. A method of automatic representation of data, comprising:
organizing a substantial dataset in a manner through which it can serve as an input to at least one of a machine learning model and an artificial-intelligence application,
wherein the machine learning model is focused on at least one of a classification, a prediction, a pattern search, a trend search, a data cluster search, a data mining, and a knowledge discovery;
automatically creating a set of attributes for at least one of the machine learning model and the artificial-intelligence application that is usable on the substantial dataset; and
efficiently generating a data representation for at least one of the machine learning model and the artificial-intelligence application that is usable on the substantial dataset.

2. The method of claim 1 further comprising:
creating additional sets of attributes to be used by at least one of an ensemble of machine learning models whereby each single set of attributes is a basis of a single machine learning model in the ensemble.

3. The method of claim 2 further comprising:
comparing data objects by means of whether they have same combinations of attribute values on each single set of attributes;
computing a similarity score between the objects as an amount of the sets of attributes for which the corresponding combinations of attribute values are the same;
forming a query-by-example artificial-intelligence application through the comparing data objects by means of whether they have the same combinations of attribute values on each single set of attributes; and
computing the similarity score between the objects as the amount of the sets of attributes for which the corresponding combinations of attribute values are the same.

4. The method of claim 3 further comprising:
using the query-by-example artificial intelligence application as a component of at least one of a diagnostic application of the machine learning model which searches for similar historical data objects to a currently diagnosed data objects and a data labeling application which searches for at least one of a maximally similar and a maximally diverse data objects to be labeled.

5. The method of claim 1 further comprising:
collecting a set of parameters that can be applied to the substantial data in an information library,
wherein the information library is a repository of attribute specifications, and
wherein the attribute specifications have hyperparameters that are usable to compute various alternative versions of the attributes; these versions may have different practical properties that make some of them more useful for any one of training the accurate machine learning models and designing an efficient artificial intelligence application.

6. The method of claim 5 further comprising:
using an information pipeline module to compute a set of data transformations and perform calculations of the attribute values; and
applying the attribute specifications from the information library on the substantial data and storing result data as in an efficient data storage,
wherein computed attribute values are storable in a compressed format to decrease required storage size.

7. The method of claim 6 further comprising:
interpreting a description of the hyper parameter space when applying the method to create the automatic representation of data suitable for any of the machine learning models, intelligent algorithms, and artificial intelligence applications;
interacting with a user of the machine learning model through an information-finder module,
wherein the user is asked to define at least one of:
a type of the substantial data,
a location where the substantial data and attribution specifications are stored,
an upload method of the substantial data, and
a semantic type of the substantial data; and
determining which type of data transformation to use when identifying the space of parameters based on the semantic type when the description is interpreted.

8. The method of claim 7 further comprising:
optimizing the automatic representation in a compute-efficient manner that is suitable for the machine learning model based on the semantic type using the description of the hyper parameter space.

9. The method of claim 1:
estimating whether a particular attribute specification is useful for a particular substantial dataset, based on the semantic type and using the description of the hyper parameter space;
learning a set of attributes in the substantial data that are important by applying an attribute selection/extraction method; and
using the set of identified important attributes to make predictions on new data.

10. The method of claim 1:
wherein the substantial dataset is an unstructured data that is so voluminous that traditional data processing methods are unable to discreetly organize the data in a structured schema.

11. The method of claim 10 wherein the method further comprising:
analyzing the substantial dataset computationally to reveal at least one pattern, trend, and association relating to at least one of a human behavior and a human-computer interaction.

12. The method of claim 11 wherein the method further comprising:
sampling randomly a space of possible hyper parameter settings whereby the sampled setting becomes a means to compute corresponding attributes and evaluate them through a random-sampling application.

13. The method of claim 12 further comprising:
applying intelligence to the random sampling through at least one of a stratified sampling technique, a systematic sampling, a cluster sampling, a probability proportional to size sampling, and an adaptive sampling method.

14. The method of claim 1 further comprising:
forming a data representation in a form of a tensor;
storing the tensor in a single cell of the substantial database;
wherein the tensor is at least one of a multi-dimensional array and a mathematical object to generalize scalars, vectors, and matrices;
conveniently using the tensor in a machine learning method by retrieving the data from the single cell of the substantial database,
wherein the substantial dataset includes a set of columns comprising any one of integers floats, characters, strings, and categories; and
fitting the machine learning model using the tensor.

15. The method of claim 1 further comprising:
evaluating a chosen attribute using a heuristic evaluation approach,
wherein the heuristic approaches comprise at least one of an entropy of a decision class conditioned by the chosen attribute to be evaluated, an accuracy of the machine learning model trained on the representation extended by the chosen attribute; and
creating a score for the chosen attribute;
permitting an external domain expert to assist in fine-tuning the method of automatic representation of data.

16. The method of claim 15 further comprising:
assuring a diversity of hyper parameter settings corresponding to the chosen attributes while constructing the set of attributes;
defining a metric over a space of hyperparameters to indicate which settings any of closer to each other or distant from each other; and
ensuring a complementary mix of sources of information required for calculating the set of attributes when a multimodal data comprising any of a set of images, videos, audio, and text data.

17. The method of claim 16 further comprising:
maintaining a heatmap of hyper parameter settings for which corresponding attributes have been already examined, whereby that heatmap registers which attributes were evaluated as good and which as bad during an iterative process of selecting attributes and adding best ones to the set of attributes,
wherein iteration of the heatmap is additionally used during a process of random selection of the hyperparameters settings whereby the settings which are closer based on a metric over the space of possible hyper parameter settings to the good ones and more distant from the bad ones examined before.

18. A method comprising:
selecting for a chosen attribute for a data organization using machine learning by ingesting a dataset,
wherein the dataset is any one of an unstructured data, a multimodal data, and an original data;
selecting at least one parameter and at least one specification using an information pipeline module for the chosen attribute,
wherein at least one specification is any one of a representations specification, a transformation specification, and a modeling specification;
generating a result data from the dataset using at least one parameter and the at least one specification;
automatically identifying an optimal attribute using at least one parameter and at least one specification;
evaluating a data attribute using a predefined quality measure, such as a mutual information function, a gini impurity, a class discernibility measure, and others selecting an additional attribute from the possible attribute specification and parameter tuples based on the evaluation using a predefined quality measure; and
updating the result data usable in the machine learning model with the additional attribute.

19. The method of claim 18 further comprising:
wherein the at least one parameter is any one of a usefulness evaluation, a bayesian optimization, an uncertainty minimization, and a diversity-based feature selection.

20. The method of claim 19 further comprising:
wherein evaluating the candidating attribute is done using any one of a heuristic evaluation, the mutual information function, gini impurity, class discernibility measure, a feature diversity incorporation, and an extrinsic feedback.

21. The method of claim 18:
wherein the dataset is an unstructured data that is so voluminous that traditional data processing methods are unable to discreetly organize the data in a structured schema.

22. The method of claim 21 wherein the method further comprising:
analyzing the dataset computationally to reveal at least one pattern, trend, and association relating to at least one of a human behavior and a human-computer interaction.

23. The method of claim 22 wherein the tracking of human behavior to result an algorithm in forming automatic recommendations for additional modalities and sources of data to be analyzed.

24. The method of claim 23 wherein a human-computer interaction to comprise of presenting the selected candidates for attributes to a human, whereby an attribute presentation to include at least one of:
presenting an attribute values for examples of data objects, and
presenting the attribute specifications in terms of sources of information, modality and hyper parameter settings that are used to define them.

25. A method of automatic representation of data, comprising:
automatically creating a set of attributes for at least one of a machine learning model and an artificial-intelligence application that is usable on the substantial dataset;
efficiently generating a data representation for the at least one of the machine learning model and the artificial-intelligence application that is usable on the substantial dataset;
collecting a set of parameters that can be applied to the substantial data in an information library;
using an information pipeline module to compute a set of data transformations and perform calculations on the attributes; and
applying the attribute specifications from the information library on the substantial data and storing a result data as in the machine learning model.

26. The method of claim 25 further comprising:
interpreting a description of the hyper parameter when applying the method to create the automatic representation of data to apply an accurate semantics.

27. The method of claim 26 further comprising:
communicating with a user of the machine learning model through an information-finder module;
wherein the user to define at least one of:
a type of the substantial data,
a location where the substantial data and attribution specifications are stored,
an upload method of the substantial data, and
a semantic type of the substantial data.

28. The method of claim 27 further comprising:
determining which type of data transformation to use when identifying the set of parameters based on the semantic type when the description is interpreted.

29. The method of claim 28 further comprising:
optimizing the automatic representation in a compute efficient manner that is suitable for the machine learning model based on the semantic type using the description of the hyper parameter.
